(19) United States
(12) Patent Application Publication
(10) Pub. No.: US 2007/0289842 A1
(43) Pub. Date: Dec. 20, 2007

(54) APPARATUS AND METHOD FOR TRANSPORTING AND ARRANGING CONTAINERS

(75) Inventor: Eduard Hendrikus Johannes Damhuis, Bousval (BE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FMC TECHNOLOGIES, INC., Houston, TX (US)

(21) Appl. No.: 11/764,671

(22) Filed: Jun. 18, 2007

Related U.S. Application Data
(60) Provisional application No. 60/814,170, filed on Jun. 16, 2006.

(51) Int. Cl. B65G 47/26

(52) U.S. Cl. 198/434

(57) ABSTRACT

Registration transfer unit (26) receives containers (C) in random intervals and then places such containers in a transfer conveyor (30) moving generally laterally to the registration transfer unit. The registration transfer unit is movable relative to and with the transfer conveyor to index the registration transfer unit with cells (262) of the transfer conveyor and maintaining such indexed relationship while the containers are transferred from the registration transfer unit to the transfer conveyor. The containers are then transferred from the transfer conveyor to an infeed conveyor (32) to carry the containers to a pick-up unit (34) that removes a selected number of containers at a time from the infeed conveyor.

### CROSS-REFERENCE TO RELATED APPLICATION

This application claims the benefit of U.S. provisional patent application No. 60/814,170, filed Jun. 16, 2006, the specification of which is incorporated herein by reference.

### TECHNICAL FIELD

The present application pertains to transporting and arranging items or containers at a high rate of speed, and more particularly receiving items or containers at random intervals and arranging and presenting such items/containers in sets at precise, fixed spacing or other desired configurations for further transport, processing, packaging, etc.

### BACKGROUND

In normal manufacturing and processing of products and goods, it is often necessary to transport and feed such goods or containers holding such goods from station to station. In this regard, it may be desirable to arrange the products/containers in desired sets, configurations, orientations, etc. This often needs to be carried out at high rates of speed, so as not to hinder the manufacturing or processing of the products involved. One challenge in this regard is that often products or containers are not available for further transport, processing, packaging, at a uniform frequency or rate; but, rather, at random or variable timing. However, in the next step in manufacturing or processing it may be necessary to have sets of the products/containers assembled or arranged; for example, for sterilizing the products/containers in a batch process or for packaging the products/containers in units. The present invention addresses how this may be carried out with precision, speed, and without large space requirements.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An apparatus for feeding items in a desired configuration includes: a registration transfer unit for receiving items at random or nonuniform intervals; a conveyor system defining individual cells disposed along the conveyor system sized and configured to receive items from the registration transfer unit; and a registration system for positioning or indexing the registration transfer unit with a desired cell of the conveyor system and moving the registration transfer unit in unison with the desired cell to maintain the registration transfer unit in registration with the desired cell during transfer of the item from the registration transfer unit to the conveyor system cell.

In a further aspect of the apparatus, the registration transfer unit includes an inlet section for receiving items and an exit section for exiting items from the registration transfer unit, and further the registration system is operable to move the registration transfer unit relative to the conveyor system substantially lengthwise of, and relative to, the conveyor system to index the exit section of the conveyor transfer unit with the desired conveyor cell and retain the exit section of the registration transfer unit in registry with the cell during transfer of the container from the registration transfer unit to the conveyor cell.

In a further aspect of the apparatus, the conveyor system is disposed angularly to the registration transfer unit.

In a further aspect of the apparatus, a motive system is provided for moving the items to the registration transfer unit, wherein the motive system may include a moving belt underlying the registration transfer unit.

In a further aspect of the apparatus, the registration system includes an actuator that operates on the registration transfer unit to move the registration transfer unit along and relative to the length of the conveyor system.

In a further aspect of the apparatus, the registration system also includes a sensing system to sense the position of the registration transfer unit relative to the conveyor system and a control system to control the operation of the actuator to position the registration transfer unit relative to the conveyor system as desired.

In a further aspect of the apparatus, the conveyor system includes a first conveyor configured to define sequentially arranged cells for receiving items from the registration transfer unit; and a second conveyor for receiving items from the first conveyor and presenting the items so that the items can be removed from the second conveyor in desired groupings of a specific number of items.

In a further aspect of the apparatus, the items constitute containers to hold product.

In a further aspect of the apparatus, the containers are rectilinear in configuration.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of the present disclosure;

FIG. 2 is a top view of the present disclosure;

FIG. 3 is an elevational view of the present disclosure viewing a conveyor system in the side elevation;

FIG. 4 is a further elevational view of the present disclosure taken 90° from FIG. 3, showing an end view of the conveyor system;

FIG. 5 is an isometric view of the present disclosure focusing on a support frame structure;

FIG. 6 is an enlarged fragmentary view of the present disclosure focusing on a registration transfer unit;

FIG. 7A is a top view of the aspect of the present disclosure shown in FIG. 5;

FIG. 7B is a bottom view of an aspect of the present invention shown in FIG. 7A;

FIG. 8 is a fragmentary pictorial view of the present disclosure illustrating a transfer conveyor of the conveyor system;

FIG. 9 is a fragmentary pictorial view of the present disclosure illustrating an infeed conveyor of the conveyor system; and

FIG. 10 is a fragmentary schematic view of the present disclosure illustrating the interface between the transfer conveyor and the infeed conveyor of the conveyor system.

### DETAILED DESCRIPTION

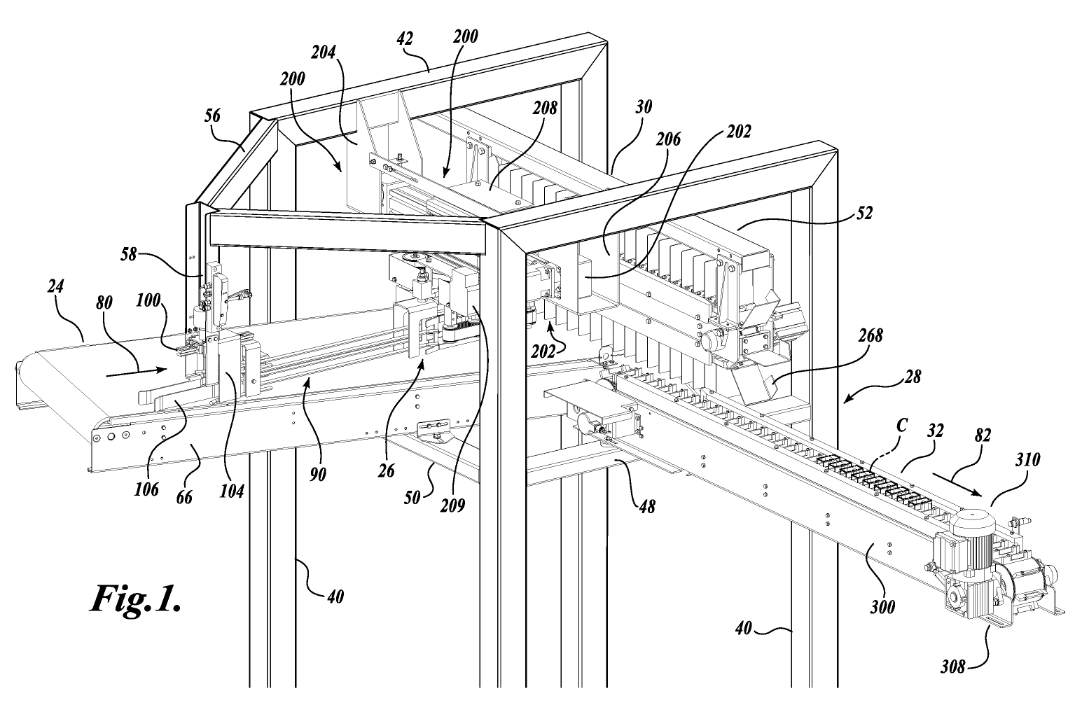

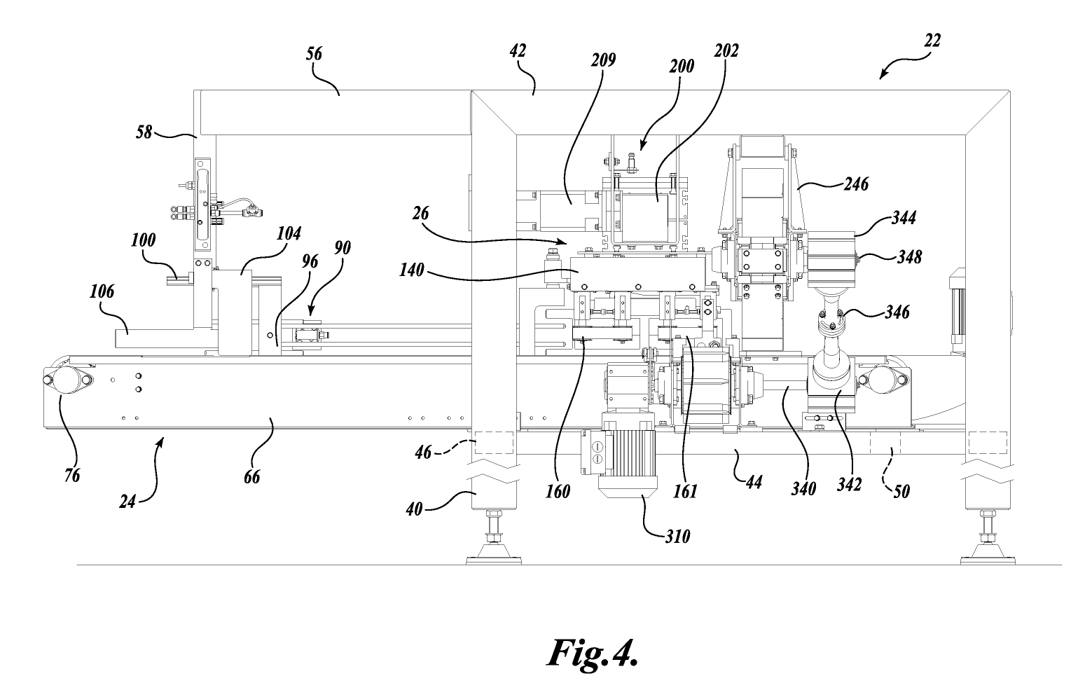

Referring initially to FIGS. 1-4 of the present disclosure, an apparatus and system 20 for transporting, arranging, and feeding a plurality of items, for example, containers C, in a desired configuration is illustrated as including an elongate flat belt 24 mounted to a frame 22 to cantilever therefrom. The flat belt 24 advances the containers C to and through a registration transfer unit 26 which receives the containers in varied or random intervals and presents and releases the containers at specified intervals to a conveyor system 28 disposed generally laterally to the registration transfer unit. The conveyor system 20 includes a first, transfer conveyor 30 for moving the containers generally laterally to and away from the registration transfer unit to deposit the containers on a second, infeed conveyor 32 wherein the containers are arranged in fixed position relative to each other. The infeed conveyor 32 presents the containers at desired relative position to each other, and optionally in desired groupings, to a pickup unit (not shown) which removes a selected number or set of containers C at the same time from the infeed conveyor for further processing, for packaging, for inspection or other purpose.

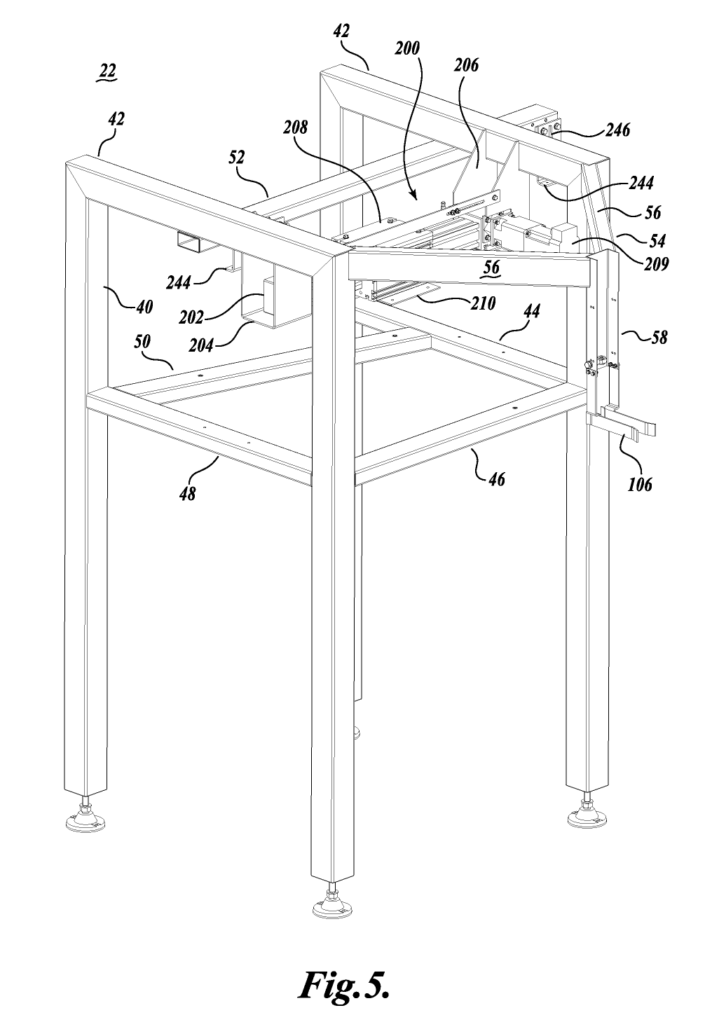

Next, describing the above major components of system 20 in greater detail, referring specifically to FIGS. 1, 2, 3, 4 and 5, frame 22 is generally of upright rectilinear shape having four legs 40 joined together at their upper ends by top cross members 42. The legs 40 and cross members 42 may be constructed of appropriate structural elements, such as square, rectangular, or circular hollow beams. Alternatively, these structural members may be constructed from channels, I-beams, or other components. An upper mid-rise platform is formed on the frame 22 by stringer members 44, 46, 48, and 50. The stringer members 44, 46, and 48 span between adjacent legs 40 whereas stringer member 50 is skewed extending from one leg 50 to an intermediate point on stringer member 44. The stringer members may be composed of numerous different structural members, including hollow rectangular members, channel members, I-beams, etc. The frame 22 also includes an upper cross member 52 that spans between the top cross members 42, the purpose of which will be described below. The frame in addition includes a generally D-shaped substructure 54 composed of two arms 56 that cantilever outwardly from legs 40 to intersect each other at the upper end of a downwardly depending hangar beam 58.

While system 20 is illustrated as mounted on frame 22, it is to be appreciated that other structures can be used in place of frame 22. Also, the frame can be of other configuration from that shown in FIGS. 1-5.

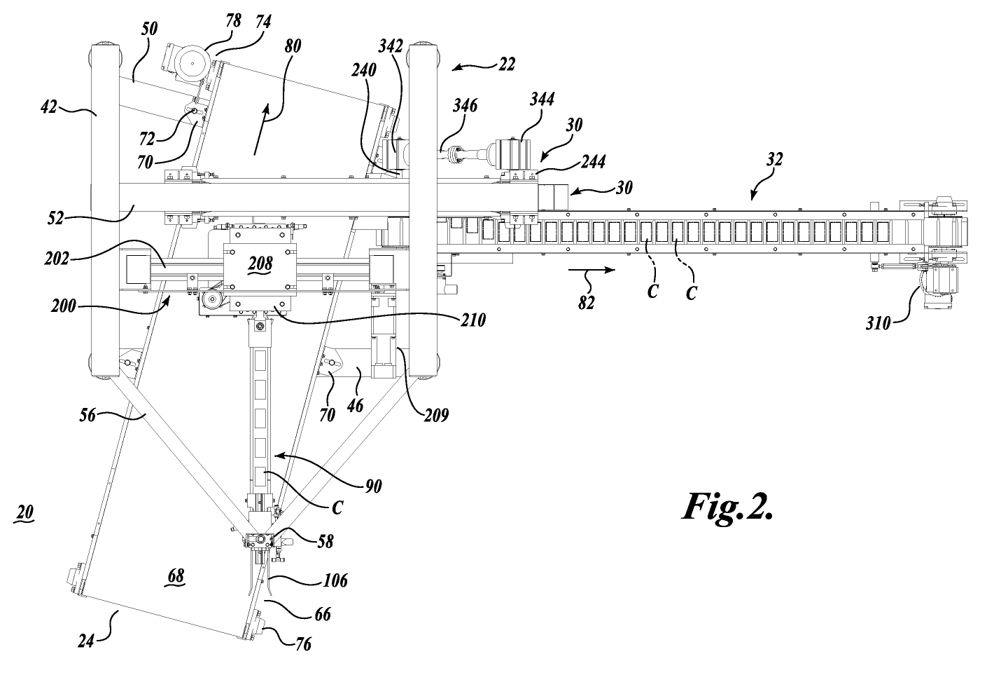

Referring specifically to FIGS. 1-4, belt 24 is illustrated in the form of a rectilinear flat belt structure having a frame structure 66 for supporting an endless belt 68. The frame structure 66 is carried by frame 22 wherein the frame structure 66 overlies and is connected to frame stringer members 46 and 50. Mounting brackets 70 extend laterally outwardly from the sides of belt frame structure 66 to overlie the upper surfaces of stringers 46 and 50 and are attached to such stringers by hardware members in the form of bolts 72. Elongate slots are formed in the mounting brackets 70 so as to be able to adjust the angular orientation of the belt 24 relative to a frame 22, thus also relative to the conveyor system 28. A drive pulley system 74 is mounted to the leading end of frame structure 66, and a driven pulley system 76 is mounted to the trailing end of the frame structure. The drive pulley 74 is powered by a drive motor system 78 drivingly connected to the drive pulley system 74 thereby to power the belt 68 in the direction of arrow 80, shown in FIGS. 1 and 2. The belt 24 is disposed at an acute angle relative to the direction of travel of the conveyor system 28 as designated by arrow 82. Thus, it will be appreciated that the moving belt 68 has a velocity component in a direction parallel to the direction of travel of the conveyor system 28.

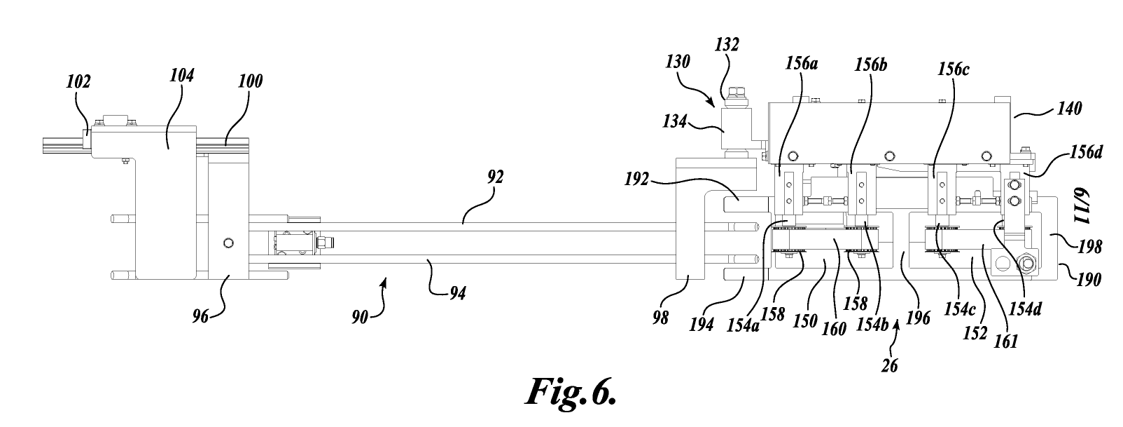

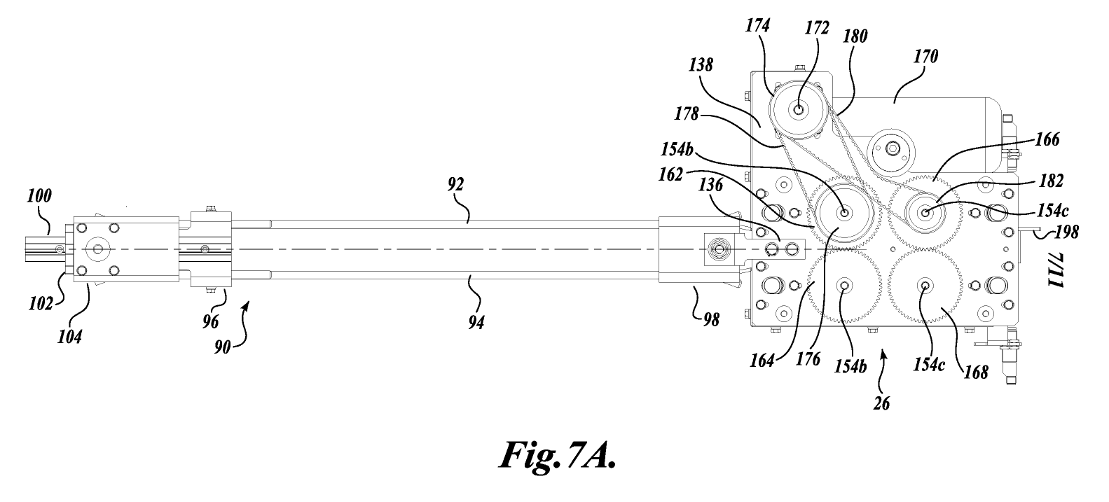

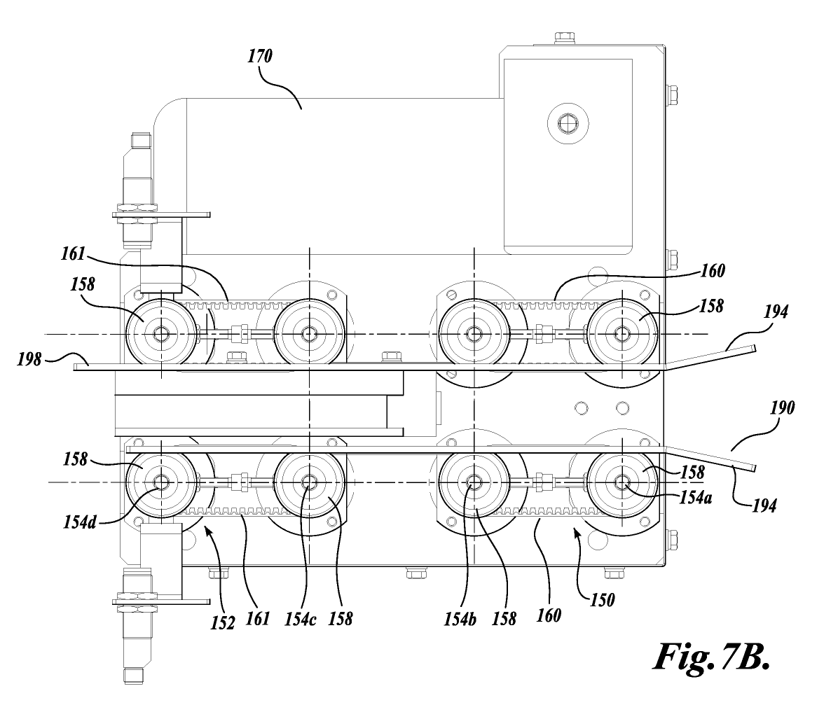

The flat belt 24 provides a motive system for advancing containers C through a guide system 90 connected to the inlet side of registration transfer unit 26 as shown in FIGS. 1, 2, and 4. The guide system and registration transfer unit are shown in enlarged view in FIGS. 6, 7A, and 7B. The guide system includes upper and lower laterally spaced apart side rails 92 and 94 connected adjacent the inlet or upstream end portion of the guide rail by a generally upwardly closed U-shaped bracket 96 and connected at their downstream or outlet end portion by a comparable, upwardly closed U-shaped bracket 98. A longitudinal slide structure 100 cantilevers upstream from the top of bracket 96 to engage with a sliding member 102 attached to a generally U-shaped slide bracket 104. The slide bracket 104 is configured to couple to the lower end of hanger beam 58, which beam thereby supports the inlet end of the guide system. By this structure, the guide system is able to move longitudinally relative to the supported bracket, for example, as the registration transfer unit moves relative to, or along with, the moving transfer conveyor 30 as described below. As shown in FIGS. 2, 4, and 5, a pair of lead-in arms 106, composed of elongate flat stock material, are disposed vertically edgewise to cantileve upstream from the lower portion of the hanger beam 58 to serve as a lead-in guide for containers C presented to the guide system from a supply source, not shown.

It will be appreciated that the containers C that are disposed within the guide system 90, are moved along the guide system by the underlying belt 68. Although the belt 68 is somewhat skewed relative to the longitudinal center line of the guide system, the belt nonetheless has a major velocity component in a direction parallel to the length of the guide system.

The registration transfer unit 26 is attached to the forward end of the guide system 90 by a swivel connection link 130 attached to the upper surface of U-bracket 98 via pivot pin 132 that extends through a central bore formed in a rearward boss portion 134 of the link to engage with the upper web portion of the U-bracket 98. It will be appreciated that in this manner, the forward or exit end portion of the guide system is able to pivot relative to the rear or entry end portion of the registration transfer unit, for example, as the registration transfer unit moves relative to or along with the traveling transfer conveyor 30. The connection bracket 130 includes a forward tab portion 136 that is connected to the base 138 of the overhead drive box 140 of the registration transfer unit.

The registration transfer unit includes a pair of laterally spaced apart, rearward or inlet side belt systems 150 and a pair of laterally spaced apart outlet or forward side belt systems 152 that depend downwardly from base 138. The two side belt systems are of similar construction. Each includes drive shafts 154 that extend through the center of drive hubs 156 that extend downwardly from the underside of base 138 and are securely attached thereto. A belt sheave 158 is attached to and driven by the lower end portion of the drive shafts 156, and endless belts 160 and 161 are trained over the sheaves.

Referring specifically to FIG. 7A, a drive gear 162 and a driven gear 164 pair of the inlet side belt systems 150 are attached to the upper end portions of drive shaft 154b just above the upper surface of the base 138. Gears 162 and 164 are of the same size. Similarly, a gear pair composed of a drive gear 166 and a drive gear 168 are attached to the upper end portions of drive shafts 154c of the two forward side belt systems 152. Gears 166 and 168 likewise are of the same size. Gears 162 and 166 are driven by common motor 170 through the drive shaft 172 connected to a belt double drive sheave 174. A drive sheave 176 is coupled to the upper end of belt drive shaft 154b, with the sheaves 174 and 176 coupled together by a drive belt 178. The belt sheave 174 is constructed with two belt grooves, with the second belt groove receiving a belt 180 that trains over a driven sheave 182 coupled to the upper end of belt drive shaft 154c. As shown in FIG. 7A, the belt sheave 176 is larger than the belt sheave 182. As a consequence, belt sheave 182 is driven at a faster speed than belt sheave 176. As a result, the exit belts 161 move at a faster speed than the inlet belts 160. This allows a separation to occur between the container C that is in registry with the belts 161 relative to the next rearwardly adjacent container that is in registry with the belts 160. This enables a container at the outlet of the registration transfer unit to be loaded onto the conveyor system while the next to arrive container is still progressing forwardly in the registration transfer unit via belts 160.

As shown in FIGS. 6 and 7B, the registration transfer unit includes a side guide 190 extending along each side of the path of the containers, and thus is positioned between the side belt systems centrally through the registration transfer unit. The side guides are positioned just laterally outwardly of the inner runs of the belts 160 and 161 so that the belt inner runs bear against the sides of the containers while the slightly laterally outwardly positioned guides keep the containers traveling forwardly as desired. The side guides include upper and lower rails sections 192 and 194 as well as intermediate and forward upright sections 196 and 198 connecting the rail sections. The upright section 198 extends forwardly of the belts 161 along the left side of the registration transfer unit as shown in FIGS. 7A and 7B, thereby to serve as a guide for the container as the container moves from the registration transfer unit to the transfer conveyor. The upper and lower rails 192 and 194, at the lead-in end of the transfer unit, are flared out, as shown in FIG. 7B, to assist in receiving the containers C therein.

It will be appreciated that as the containers travel through the guide system and registration transfer unit, they are also supported and urged forwardly by the underlying belt 24.

As shown in FIGS. 1-5, the registration transfer unit 26 is coupled to an overhead drive system 200 which moves registration transfer unit generally laterally and thus lengthwise of the conveyor system 28 thereby to place the registration transfer unit in desired registry with the conveyor system during transfer of the containers from the registration transfer unit to the conveyor system, as described below. Although the drive system 200 can take many forms, in one embodiment, the drive system is in the form of an elongated linear actuator having a beam portion 202 that spans between the top cross members 42 of frame 22. The ends of the beam portion are supported by formed brackets 204 and 206 that depend downwardly from the frame cross members 42. The linear actuator also includes a carriage 208 that is powered to move lengthwise of the actuator beam 202 by a belt drive system in a known manner. In a standard arrangement, a servo motor 209 is used to power the belt drive system. Attachment flanges 210 extend laterally outwardly from the lower portion of a carriage 208 for attachment to the top of registration transfer unit 26. It will be appreciated that other drive systems may be employed in conjunction with the registration transfer unit in place of a drive system 200 including, for example, rack and pinion systems, pivot arm systems, multiple linkage systems, cable systems, hydraulic systems, electrical systems.

The conveyor system 28 includes a transfer conveyor 30 shown in FIGS. 1-4 and 8. The transfer conveyor may be of various configurations and constructions, with one form of the conveyor shown in FIGS. 1-4. The transfer conveyor is oriented generally perpendicular to the registration transfer unit 26 and is elongate in construction. In this regard, the transfer conveyor includes a frame 230 composed of a pair of elongate, parallel side members 232 with a drive sheave assembly 234 at one end and the drive sheave assembly 236 at the opposite end over which a cog belt assembly 240 is trained. The transfer conveyor 30 also includes mounting flanges 242 extending transversely outwardly from the upper edges at each end of the side members 232 for mounting the transfer conveyor to the end portions of upper cross member 52 of the frame 22. In this regard, the mounting flange 242 meets with corresponding flanges 244 which extend laterally from the lower portion of mounting brackets 246 which depend downwardly from the sides of the cross beam 52.

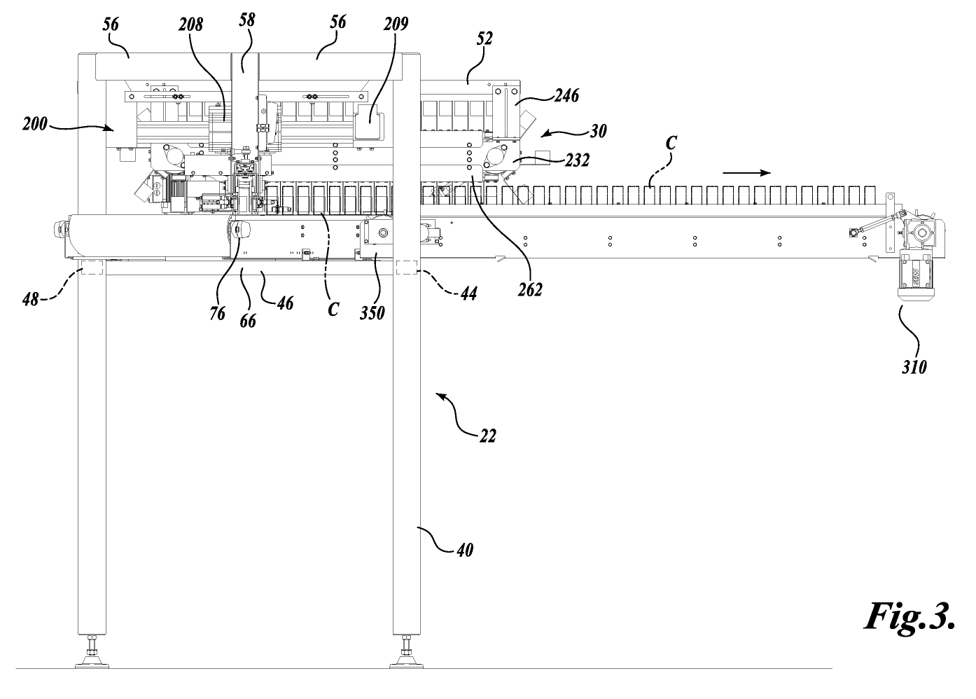

A pusher plate structure 260 is mounted to the cog belt so that adjacent pusher plate structures define flights, cells or pockets 262 for receiving containers, as described below. Each of the pusher plate structures 260 includes a transverse mounting flange portion 264 which is bolted or otherwise securely fastened to the cog belt. The pusher plate structures also include a rear pusher wall 266 that extends from the mounting flange away from the side support blocks. Each pusher plate structure also includes an end wall 268 that extends transversely from one edge of the pusher wall towards the adjacent end wall of the adjacent pusher plate structure. Such end walls serve to restrain the containers when the containers C are transferred into the cells 262 by the registration transfer unit. As shown most clearly in FIG. 3, when the pusher plate structure rides along the underside of the transfer conveyor frame, the distal edge of the pusher plate structure is spaced upwardly above the elevation of the belt 24 so as not to interfere with the movement of the belt. In this manner, the container C continues to be supported by belt 24 while being pushed laterally relative to the registration transfer unit by the transfer conveyor.

Next, referring specifically to FIGS. 1-4, 9 and 10, infeed conveyor 32 is positioned parallel and to the side of transfer conveyor 30 on the side thereof facing registration transfer unit 26. The infeed conveyor 32 extends beyond the forward end of the transfer conveyor 30, see in particular, FIGS. 1-3.

The infeed conveyor 32 is elongate in form, being composed of a pair of spaced apart side plates 300 for supporting at the distal, forward end a drive sheave assembly 302 and at the proximal, rearward end a driven sheave assembly 304 for driving and supporting a cog belt 306 that spans the sheaves 302 and 304. Transverse mounting brackets 308 extend transversely from the lower edge portions of the side plates 300 at the distal ends thereof for connecting the infeed assembly to a support structure, not shown. The cog belt 306 is driven by a motor 310 connected to a drive shaft 312 via transverse or right angle gear drive box 314. The drive shaft 312 is drivingly connected to the drive sheave assembly 302 in a well known manner.

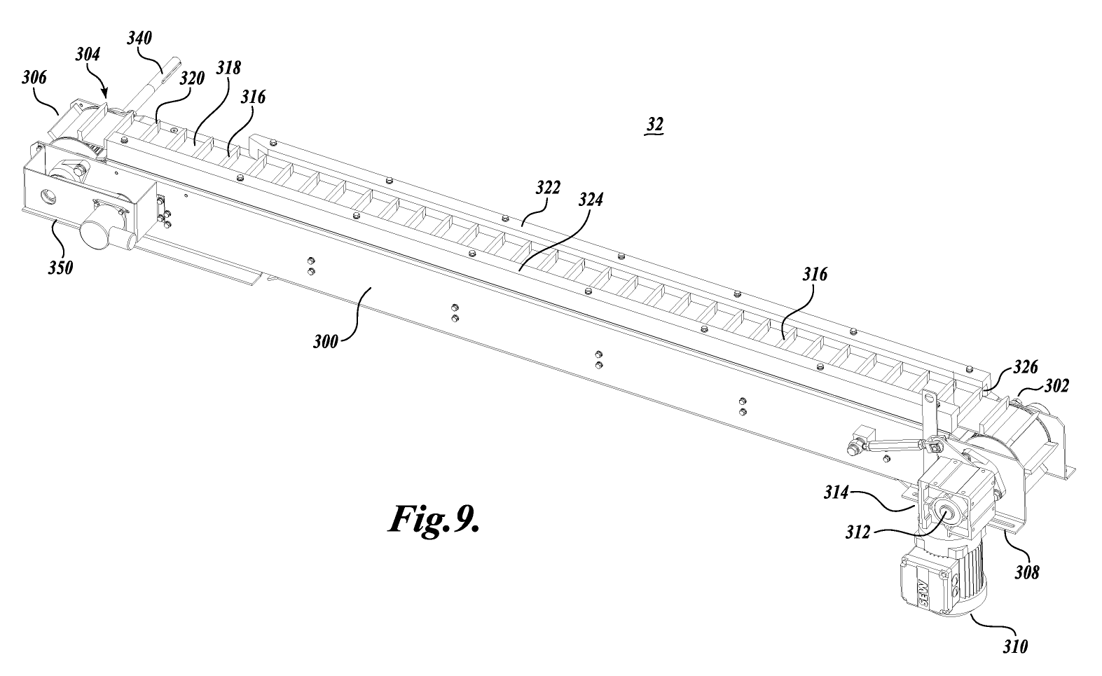

The cog belt 306 includes uniformly spaced apart ribs 316 that extend upwardly from the belt surface so as to define uniform cells or pockets 318 between adjacent ribs. As shown in FIG. 9, at one end 320, each of the ribs 316 is tapered so as to define a lead in for the cells 318, to facilitate the reception of containers C into these cells as described below.

As perhaps most clearly shown in FIG. 9, guides 322 and 324 extend along the upper edge portion of the side plates 300 to restrain and guide the cog belt 306. The guides 322 and 324 include an undercut portion 326 for receiving the end portions of the ribs 316 therein. The guides 322 and 324 are attached to the side plates 300 by any convenient means, for example, by hardware members extending downwardly through the guides and into the side plates 300.

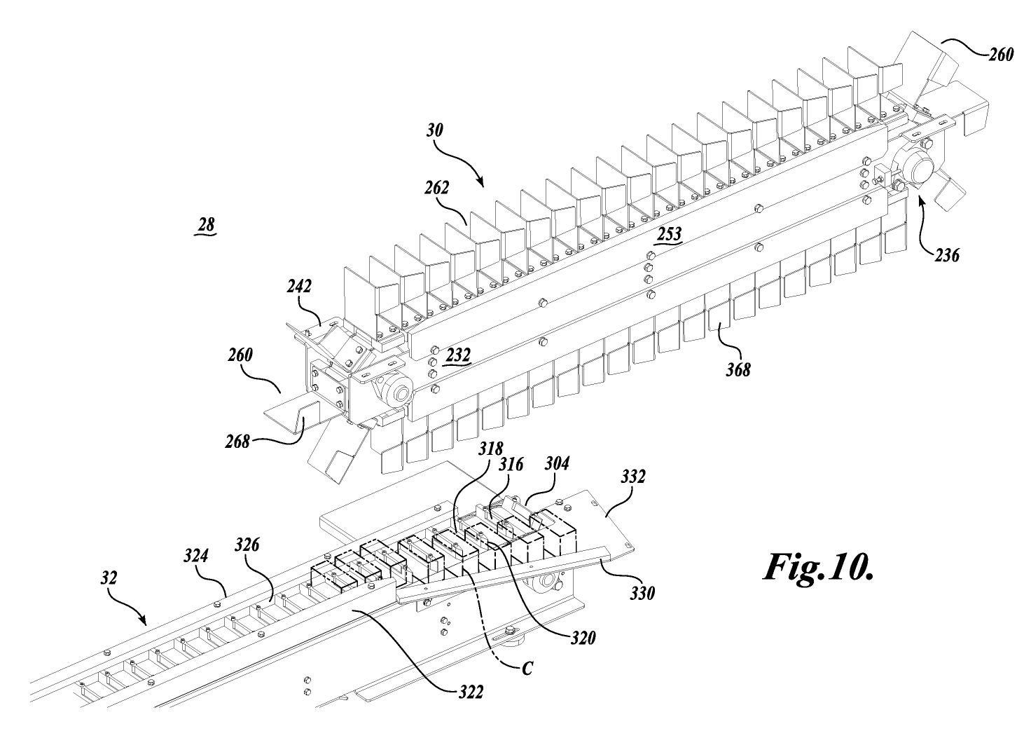

As shown in FIG. 9, the guide 322 at the inlet end portion of the infeed conveyor is shorter than the guide 324 so that the guide does not extend along a portion of the cog belt. This portion of the cog belt corresponds to an overlap with the distal end portion of the transfer conveyor. It is along this section of the infeed conveyor that the containers C are transferred from the transfer conveyor to the infeed conveyor. Referring to FIG. 10, this is accomplished by use of a guide rail 330 that extends diagonally relative to the length of the infeed guide. This guide rail is supported by a death plate 332 which spans between the belt 24 and the infeed conveyor 32 to also support the containers as the containers are pushed forwardly by the transfer conveyor, and then forced sideways by the guide rail 330 so that the containers leave the transfer conveyor cell 262 to enter an infeed conveyor cell 318. As will be appreciated, the upper surface of the death plate 332 is at an elevation corresponding to the elevation of the cog belt 306 or at a slightly higher elevation so that the container C does not get caught up against the side of the cog belt. As also will be appreciated, the tapered ends 320 of the cog belt ribs 316 facilitate the containers entering into the infeed conveyor cells 318 by forming a lead-in to the cells for the containers.

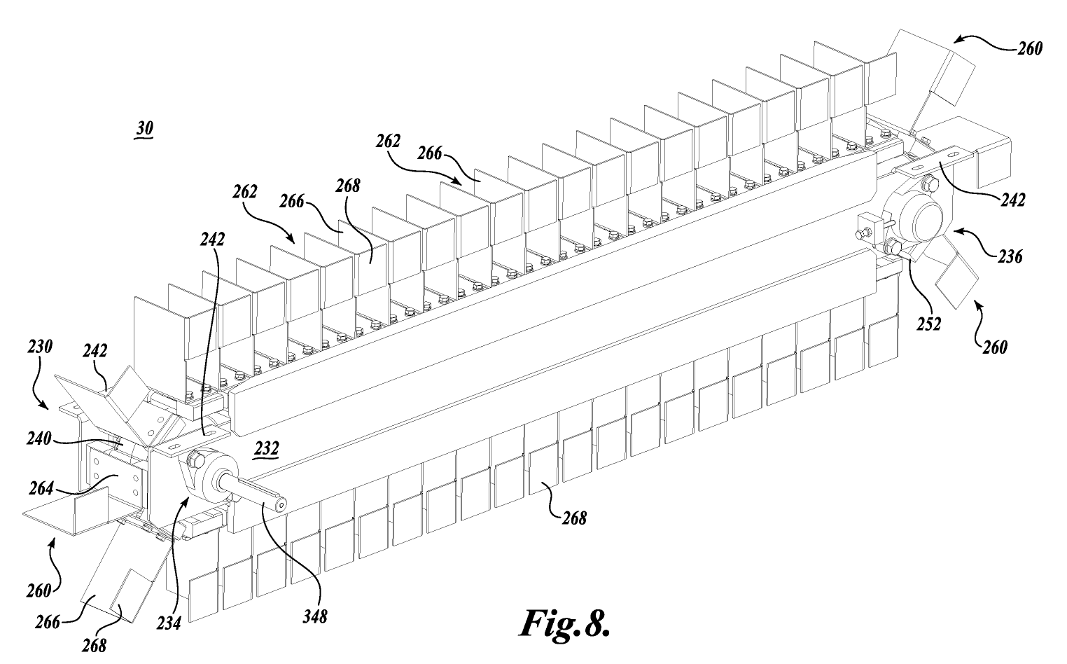

As will be appreciated, it is important that the cells 262 of the transfer conveyor 30 be in registry with the cells 318 of the infeed conveyor 32. In this regard, it is also important that the speed of the transfer conveyor belt 240 be the same as the speed of the infeed conveyor belt 306. This is accomplished by drivingly inner-connecting the transfer conveyor 30 with the infeed conveyor 32. In this regard, a drive shaft 340 extends outwardly from the infeed conveyor drive sheave assembly 304 to be coupled with a transverse drive gear box 342 which in turn is drivingly coupled to a further transverse drive gear box 344 by a transfer shaft 346. The right hand drive gear box 344 is in turn drivingly coupled to a driven shaft 348 that extends outwardly from drive sheave assembly 234 of the transfer conveyor 30, see FIG. 8. In this manner, the belt 240 of transfer conveyor 30 and the belt 306 of the infeed conveyor 32 are coordinated to be driven at the same speed, whereby the belt cells 262 and 318 will always be in registry with each other.

Referring primarily to FIGS. 3 and 9, an encoder system 350 is illustrated as drivingly coupled to drive sheave assembly 304 of the infeed conveyor. The encoder system monitors the movement of the cog belt 306 which in turn is related to the movements of the pockets or cells 262 of transfer conveyor 30. Signals from the encoder system 350 are transmitted to the overhead drive system 200 to control the operation of servo motor 209 thereby to cause the registration transfer unit 26 to be placed in registry with a pocket or cell 262 and move along with such pocket or cell with the movement of the transfer conveyor 30. A proximity switch, electric I-beam, or other system can be utilized to determine when transfer of container C has been completed between the registration transfer unit and the conveyor pocket so that the registration transfer unit can then move to the next available empty pocket of the transfer conveyor.

Next, referring specifically to FIGS. 1 and 9, it will appreciated that containers C are in uniform spaced relationship to each other on the infeed conveyor 32. This enables a plurality of the containers C to be removed in unison from the infeed conveyor by pickup unit (not shown). The pickup unit may include an “X”/“Y” drive system (not shown) composed of, for example, parallel linear actuators 360 disposed substantially parallel to infeed conveyor 32 to support the ends of a transverse linear actuator (not shown), the end portions of which are carried by first carriages (not shown) which ride along the longitudinal linear actuators in a well known manner. Second carriages (not shown) also ride along transverse linear actuators to carry a pickup assembly 368 (not shown). The pickup assembly may include a stationary carriage unit (not shown) coupled to second carriages and a vertically movable actuator beam (not shown) adapted to carry at its lower end an interface (not shown) that is capable of detachably attaching securely to one or more containers C being carried by transfer conveyor 32. The interface can take many forms, for example, a clamping system, a vacuum system, etc.

It will be appreciated that the pickup unit can be of various configurations other than described above. Moreover, the various actuators can be of numerous configurations and types other than as described above. Nonetheless, through the described system, containers C which are presented at random frequencies, can be assembled and presented at a desired fixed frequency individually or in desired set sizes, and also in desired physical proximity to each other in a very rapid manner, for example, in the order of at least 120 containers per minute, while occupying relatively little area.

With respect to the use of the present apparatus, containers C are presented to the infeed end of guide system 90 from one or more sources, not shown. Such containers are moved along the guide system by underlying belt 68 until such containers reach two opposed entrance side belts 160 of the registration transfer unit 26, thereupon the side belts 160 control the progress of the containers in the registration transfer unit. From the side belts 160, the containers next are engaged by opposed exit side belts 161 of the registration transfer unit, which as explained above operate at a faster speed than side belts 160, thereby to create a separation between the container within the control of side belts 161 relative to the next upstream container, still controlled by the side belts 160.

The registration transfer unit 26 is movable along the length of the conveyor system 28 so that it can be indexed or otherwise positioned, to be in registry with one of the pockets or cells 262 of transfer conveyor 30. The registration transfer unit is also movable along with the moving cell so as to remain in registry with the cell. When in such registry, the container is transferred from the registration transfer unit into the cell. This is accomplished even though the container is rectilinear in shape and closely fits within the cell.

The indexing of the registration transfer unit and the movement of the registration transfer unit with the transfer conveyor 30 is accomplished via the drive system 200. As described above, the drive system receives control signals based on information received from encoder system 350 that monitors the progress of the infeed conveyor 32 and thus also the linked transfer conveyor 30. Also, an electric eye system or other system can determine when a transfer of a container from the registration transfer system to a conveyor cell 262 has been completed so that the registration transfer unit can then be indexed relative to the transfer conveyor 30 to be in registry with the next conveyor cell, and the foregoing transfer process is repeated.

Once the container C is within a conveyor cell 262, the container is moved along the conveyor 30 by the pusher wall 266 of the cell, which pushes against one side of the container. During this movement the container is still supported by the belt 24 until the container is pushed onto a death plate 232 spanning between the belt 24 and the infeed conveyor 32, see FIG. 10. As the container C is pushed along the death plate, the container is forced sideways out of the cells 262 and into a corresponding pocket 318 of the infeed conveyor 32, through the action of a guide rail 330, which presses against the end of the container until the container is fully positioned within a pocket 318. Thereupon, the container travels forwardly along the infeed container 32 until it is removed from the infeed container by a pickup unit (not shown). The pickup unit is adapted to remove one or a set of containers C at the same time, for transfer of the containers.

It will be appreciated that by the foregoing apparatus and method, containers C, which arrive at a random or non-uniform frequency, are rapidly assembled in desired sets to be transferable to another location for further processing, for packaging, for inspection, or for other purposes. Moreover, the foregoing is accomplished within a compact, relatively small physical area.

While illustrative embodiments have been illustrated and described, it will be appreciated that various changes can be made therein without departing from the spirit and scope of the invention.

For example, rather than having the conveyor system 20 composed of a first transfer conveyor 30 and a second infeed conveyor 32, the conveyor system can be composed of a singular conveyor unit of a configuration different than described above, but wherein the containers may be removed from the singular conveyor in desired groupings or sets. Further, rather than using two conveyors to compose the conveyor system, three or more conveyors may be utilized, depending on factors such as the speed which containers or other items need to be transported and arranged in desired configurations.

Further, the foregoing detailed description describes an embodiment wherein containers containing product are transported and arranged in desired configurations and sets. Such containers may be of various shapes, sizes, and configurations, including cylindrical, square, rectilinear, spherical, etc. Rectilinear containers provide a challenge because they have no natural “lead-in” portion as would round or cylindrical containers or items. Further, the present invention could be applied to items other than containers, rather to products or items prior to being placed in a container or otherwise packaged.

Also, rather than disposing the registration transfer unit generally laterally to the length of the conveyor system, the registration transfer unit could be disposed substantially parallel to the conveyor system with the container or item exiting the registration transfer unit at a right angle thereto, rather than along the length of the registration transfer unit. Further, rather than being disposed substantially horizontally, the conveyor system may instead be inclined or substantially vertical, with the registration transfer unit being movable in the inclined or vertical direction.

In addition, the overall speed of operation of the present system 200 can be adjusted and controlled by the general speed of containers C arriving at the registration transfer unit 26 or at the guide system 90 described above. If the containers C are arriving at either the guide system 90 or registration transfer system 26 at a slower or faster overall rate, then the overall rate of the system 20 can be adjusted, including the speed of the conveyor system 28.

The embodiments of the invention in which an exclusive property or privilege is claimed are defined as follows:

1. An apparatus for transporting and arranging a plurality of containers in a desired configuration, comprising:
a. a registration transfer unit for receiving containers in random intervals and releasing the containers at specified intervals;
b. a conveyor system disposed generally transversely to the registration transfer unit, said conveyor system defining individual cells disposed along the conveyor system to receive containers from the registration transfer unit; and
c. a registration system for indexing the registration transfer unit with a desired cell of the conveyor system and moving the registration transfer unit in unison with the desired cell of the conveyor system to maintain the registration transfer unit in registration with the desired cell during transfer of the container from the registration transfer unit to the conveyor system.

2. The apparatus of claim 1, wherein:
the registration transfer unit comprising an inlet section for receiving containers and an exit section for exiting containers from the registration transfer unit; and
the registration system operable to move the registration transfer unit relative to the conveyor system substantially lengthwise of and relative to the conveyor system to index the exit section of the conveyor transfer unit with a desired conveyor cell and retain the exit section of the registration transfer unit in registry with the cell during transfer of the container from the registration transfer unit to the conveyor cell.

3. The apparatus according to claim 2, wherein the inlet section of the registration transfer unit moves containers at a first speed along the registration transfer unit and the exit section of the registration transfer unit moves the containers at a second, faster speed when transferring the containers to the conveyor system.

4. The apparatus according to claim 2, further comprising an elongated guide in registry with the registration transfer unit to direct containers to the inlet section of the registration transfer unit, said guide adapted to move with the movement of the registration transfer unit.

5. The apparatus according to claim 4, further comprising a motive system for moving the containers along the guide and into the registration transfer unit.

6. The apparatus according to claim 5, wherein said motive system comprises a moving belt underlying the elongated guide and the registration transfer unit, said belt positioned to move the containers along the guide and the registration transfer unit.

7. The apparatus according to claim 6, wherein the belt is disposed at an acute angle relative to the direction of travel of the conveyor system so that the belt generates a vector component in the direction of travel of the conveyor system.

8. The apparatus according to claim 2, further comprising a motive system applying a force on the containers to move the containers into the inlet section of the registration transfer unit and then continuing to apply a force to the containers while disposed in the registration transfer unit.

9. The apparatus according to claim 8, wherein said motive system comprises a moving belt underlying the registration transfer unit.

10. The apparatus according to claim 1, wherein said registration system comprising an actuator operating on the registration transfer unit to move the registration transfer unit along and relative to the length of the conveyor system.

11. The apparatus according to claim 10, wherein said actuator comprising a linear actuator extending generally parallel to the conveyor system.

12. The apparatus according to claim 11, wherein said registration system further comprising:
a system to monitor the position of the registration transfer unit relative to the conveyor system, and
a control system to control operation of the linear actuator to position the registration transfer unit relative to the conveyor system.

13. The apparatus according to claim 1, wherein said conveyor system comprising a first conveyor configured to define sequentially arranged cells for receiving containers from the registration transfer unit and moving such containers along the first conveyor in unison, to transmit said containers in such uniform spacing to a desired location.

14. The apparatus according to claim 13, wherein said conveyor system comprising a second conveyor for receiving containers from the first conveyor and presenting the containers so that the containers can be removed from the second conveyor in desired groupings of a specified number of containers.

15. The apparatus according to claim 14, wherein said second conveyor comprising a plurality of upwardly open pockets for receiving and transmitting the containers from the first conveyor, said pockets configured so that the containers can be removed from the second conveyor in an upwardly direction.

16. The apparatus according to claim 14, wherein said first conveyor comprising a pusher structure associated with each cell to push a container within the cell forwardly relative to the first conveyor.

17. The apparatus according to claim 16, further comprising an underlying powered belt for supporting the containers while retained by the registration transfer unit and while being transported by the first conveyor away from the registration transfer unit.

18. The apparatus according to claim 17, wherein the pusher structures are spaced above the belt.

19. The apparatus according to claim 17, further comprising a death plate to support the containers after traveling beyond the belt and before being carried by the second conveyor.

20. The apparatus according to claim 19, further comprising a transfer guide to urge containers from the first conveyor to the second conveyor as the containers move forwardly along the first conveyor.

21. The apparatus according to claim 14, further comprising a transfer guide to force containers from the first conveyor to the second conveyor as the containers move forwardly along the first conveyor.

22. The apparatus according to claim 1, wherein the registration transfer unit and conveyor system are configured to transport containers of rectilinear shape.

23. A system for feeding items arranged in a desired configuration, comprising:
(a) a conveyor subsystem divided into flights, said flights configured to receive items therein;
(b) a feed subsystem for receiving items in random intervals and transferring the items to the conveyor subsystem;
(c) a registration subsystem for indexing the feed subsystem in registration with a desired flight of the conveyor subsystem, and maintaining such registration during the transfer of the item from the feed subsystem to a flight of the conveyor subsystem; and
(d) a motive system for moving the items along the feed subsystem.

24. The system according to claim 23, wherein the registration subsystem indexing the feed subsystem with sequential flights of the conveyor subsystem to transfer items from the feed subsystem to sequential flights of the conveyor subsystem.

25. The system according to claim 23, wherein the registration subsystem comprising a servo actuator operating on the feed subsystem to move the feed subsystem into registration with a desired flight of the conveyor subsystem and maintain the registration between the feed subsystem and such desired flight as the item is being transferred from the feed subsystem to the conveyor subsystem.

26. The system according to claim 25, wherein said registration subsystem further comprises:
a sensing system to sense the positions of the flights of the conveyor subsystem; and
a control system to control the operation of the servo actuator to position the feed subsystem as desired relative to the flights of the conveyor subsystem.

27. The system according to claim 23, wherein the feed subsystem comprising an inlet section for receiving items and moving such items at a first speed along the feed subsystem and an exit section for moving the items at a second, faster speed when transferring the items to the conveyor subsystem.

28. The system according to claim 23, wherein the motive subsystem comprises a moving belt underlying the feed subsystem, said belt position to move the items along the feed subsystem.

29. The system according to claim 28, wherein the belt is disposed at an acute angle relative to the direction of travel of the conveyor subsystem so that the belt generates a vector component in the direction of travel of the conveyor subsystem.

30. The system according to claim 29, wherein the belt underlies at least a portion of the conveyor subsystem.

31. The system according to claim 23, wherein said conveyor subsystem comprising:
a first conveyor configured to receive items from the feed subsystem and move such items along the first conveyor in unison; and
a second conveyor for receiving items from the first conveyor and presenting the items to enable the items to be removed from the second conveyor in desired groupings of a specified number of items.

32. The system according to claim 31, wherein said second conveyor comprising a plurality of pockets for closely receiving the items from the first conveyor, said pockets are upwardly open so that the items can be removed from the second conveyor in an upward direction.

33. The system according to claim 31, wherein the flights of the first conveyor comprising a pusher structure to push a item within the flight forwardly relative to the first conveyor.

34. The system according to claim 33, wherein the pusher structure is spaced above the bottom of the items.

35. The system according to claim 23, wherein the conveyor subsystem is disposed angularly to the feed subsystem.

36. The system according to claim 35, wherein the conveyor subsystem is disposed substantially laterally to the feed subsystem.

37. The system according to claim 23, wherein the items are containers to hold desired items.

38. The system according to claim 37, wherein said containers are rectilinear in configuration.
